(19) United States
(12) Patent Application Publication
(10) Pub. No.: US 2013/0146548 A1
(43) Pub. Date: Jun. 13, 2013

(54) IMMERSED SCREEN AND METHOD OF OPERATION

(71) Applicants: Pierre Lucien COTE, Dundas (CA); Jeffrey Ronald CUMIN, Hamilton (CA)

(72) Inventors: Pierre Lucien COTE, Dundas (CA); Jeffrey Ronald CUMIN, Hamilton (CA)

(73) Assignee: GENERAL ELECTRIC COMPANY, Schenectady, NY (US)

(21) Appl. No.: 13/314,892

(22) Filed: Dec. 8, 2011

(51) Int. Cl. B01D 29/66; B01D 29/52; B01D 36/02; B01D 37/00

(52) U.S. Cl. 210/798; 210/791; 210/333.01; 210/323.2; 210/295

(57) ABSTRACT

A static screen has a plurality of screening bodies and a plurality of aeration devices downstream of the screening bodies. Each aeration device is associated with a set of one or more of the screening bodies. Each aeration device may be a pulsing aerator. The pulsing aerators do not all release air at the same time. Each screening body works through periods of dead end filtration separated by backwashing events. The backwashing events comprise introducing a slug or pulse of air into the bottom of the screening body. Flow through the static screen continues at all times because the screening bodies are not all backwashed at the same time. The static screen may be used to remove trash from water flowing to an immersed membrane unit. Alternatively, the static screen may be used to provide primary wastewater treatment.

### FIELD

This specification relates to screens for filtering water, to methods of operating a screen, and to methods of treating water using a screen.

### BACKGROUND

International Publication No. WO 2007/131151 describes a static screen used upstream of an immersed membrane assembly in a membrane bioreactor. In some embodiments, the screen comprises a set of vertically oriented cylindrical screening bodies mounted in a tank. The screening bodies are open at their lower ends and connected to collection pipes near the bottom of a tank. Screened water collects in the collection pipes and can then be transferred through a wall of the tank to feed the membrane assembly. Aerators are provided below the collection pipes. In one process, bubbles from the aerators are provided continuously at a low rate to interfere with solids depositing on the screening bodies. Periodically, the aeration rate is increased to decrease the density of the water upstream of the screening bodies, which causes a backwash of the screen. At the same time, the water level in the tank rises, which allows water with floated solids to overflow into a trough to be removed. The static screen removes trash from mixed liquor in the bioreactor to protect the immersed membranes.

### INTRODUCTION

The inventors have observed various issues with static screen disclosed in International Publication No. WO 2007/131151 described above. In particular, to cause a backwash the bubbles have to reduce the density of the upstream water column to the point of reversing the normal head differential across the screen. This requires a significant air flow to produce even a mild backwash. Large blowers are required, as well as fast acting valves and a controller to cycle the blowers between the backwash air flow rate and the lower continuous air flow rate. In addition to the capital cost of this equipment, the combination of backwash aeration and continuous aeration consumes a significant amount of energy. The aerators also sometimes become plugged with trash and are no longer able to clean the screen.

A static screen to be described in detail below has a plurality of screening bodies, and a plurality of aeration devices downstream of the screening bodies. Optionally, the screening bodies may be vertically oriented cylindrical screening bodies open at their bottom end. Each aeration device is associated with a set of one or more of the screening bodies. Optionally, each aeration device may be a pulsing aerator. In that case, the pulsing aerators are preferably non-synchronized such that the pulsing aerators do not all release air at the same time.

A process for operating a static screen, such as a static screen as described above, includes operating each screening body through periods of dead end filtration separated by backwashing events. The backwashing events comprise introducing a slug or pulse of air into the bottom of the screening body. With non-synchronized aerators, flow through the static screen continues at all times because the screening bodies are not all backwashed at the same time.

A static screen or screening process, for example as described or above, can be used to remove trash from water flowing to an immersed membrane unit. In this case, openings in the screen may be in a range of about 0.5 to 2.0 mm. Alternatively, a static screen or screening process can be used to provide suspended solids removal in a number of water treatment applications, including industrial and drinking water intake screening, primary wastewater treatment, and tertiary wastewater treatment. In this case, openings in the screen may be in a range of about 0.02 to 0.3 mm.

### BRIEF DESCRIPTION OF THE DRAWINGS

FIG. 1 is a schematic cross section of a tank having a static screen.

FIG. 2 is a schematic cross section of a screening body with a pulsing aerator.

FIG. 3 is an isometric view of a pulsing aerator for use with a plurality of screening bodies.

FIG. 4 is an isometric view of parts of a static screen as in FIG. 1.

### DETAILED DESCRIPTION

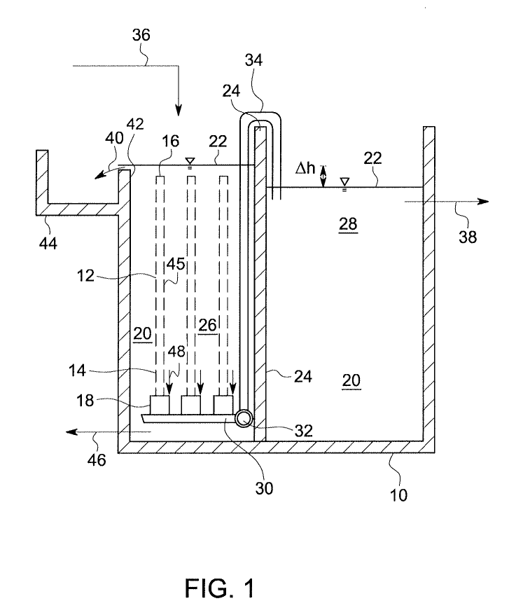

FIG. 1 shows a tank 10 containing a static screen 12. The static screen 12 has a plurality of screening bodies 14. Each screening body 14 may be made of one or more layers of a plastic or metal mesh rolled or folded into a prismatic conduit such as a tube. The top of the screening body 14 is covered with a cap 16. The bottom of the screening body 14 is open and attached to a pulsing aerator 18. As will be described further below, the pulsing aerator 18 functions as an air driven backwash device. The pulsing aerator 18 releases a slug of air, or optionally a two phase flow, from time to time into the screening body 14. Although the pulsing aerator 18 will be described as operating with air, other gasses could also be used.

The tank 10 is an open tank containing water 20 with free surfaces 22 upstream and downstream of a dividing wall 24. The dividing wall 24 divides the tank 10 into an upstream section 26 and a downstream section 28. Optionally, the downstream section 28 may be provided by a distinct tank. Further optionally, the downstream section 28 may perform another function, such as operating as a biological process tank in water treatment system or containing immersed membrane units.

The static screen 12 is located in the upstream section 26 of the tank 10. Each of its screening bodies 14 are connected to a collector pipe 30. As shown, the screening body 14 may be connected to the collector pipe 30 through a pulsing aerator 18.

Optionally, the pulsing aerator 18 may be placed in other locations, such as beside the screening body 14 or below the collector pipe 30. In this case, the pulsing aerator is fitted with an intake pipe connected to the collector pipe 30 and an outlet pipe connected to the inside of the screening body 14.

If there is more than one collector pipe 30, the collector pipes 30 may be further connected to a header 32. The collector pipe 30 or header 32 is connected to an effluent discharge pipe 34. The effluent discharge pipe 34 may pass through the dividing wall 24. Alternatively, the effluent discharge pipe 34 may pass over the dividing wall in a siphon arrangement as shown in FIG. 1. The free surface 22 in the downstream section 28 may be lower than in the upstream section 26 to provide a head difference that acts as a driving force for water to flow through the static screen 12. The head difference may be in a range or 3 to 30 cm. Alternatively, the effluent discharge pipe 34 may have a pump to provide a driving force for water to flow through the static screen 12.

Un-screened feed water 36 is added to the upstream section 26 of the tank 10. The head difference causes water to flow through the static screen 12 and out of the discharge pipe 34. Screened water 38 is continuously discharged from the downstream section 28 or directly from the discharge pipe 34. Overflow water 40 exits from the upstream section 26 over a weir 42 into a reject channel 44. The feed flow rate is generally equal to the screened flow rate plus the overflow rate, subject to adjustments for other flows. For example, settled trash may be withdrawn from time to time through a drain 46.

Each screening body 14 operates through periods of dead end filtration separated by backwashes. However, individual screening bodies 14 are backwashed at different times. The backwashing times of different screening bodies 14 may be controlled according to a regular cycle or simply not synchronized and allowed to diverge over time. On average, most, for example 80% or more or 90% or more, of the screening bodies 14 are in operation performing dead end screening while some screening bodies 14, for example 20% or less or 10% or less, are being backwashed.

Preferably, the feed flow rate is maintained above the screened effluent flow rate by a small fraction, for example 1-5%, to maintain a continuous flow over the weir 42 into the reject channel 44. The overflow 40 contains the materials rejected by the static screen 12 and released when a screening body 14 is backwashed. Since the screening bodies 14 are backwashed at different times, the rejected materials can be evacuated to the reject channel 44 without any change to height of the free surface 22 in the upstream section 26.

The excess water flow (feed flow minus screened effluent flow) plus the air released in the backwashes establishes a surface current flowing towards the weir 42 in the upstream section 26 of the tank 10. This helps carry the rejected materials to the reject channel 44. Optionally, the surface flow can be enhanced by placing a flat cover (not shown) on top of the upstream section 26 but leaving a small gap above the free surface 22. The sides of the cover are open only at the weir 42. In this way, the residual energy left in the air bubbles bursting at the free surface 22 is used to carry the overflow 40 over the weir 42.

Although the precise time of a specific backwash of a specific screening body 14 may be unknown, the average backwash frequency is controlled by the dimensions of the pulsing aerator 18 and the flow rate of air into an air inlet 48 of the pulsing aerator 18. The average backwash frequency may be on the order of 5 to 50 backwashes per hour. As discussed above, it is not necessary to sequence the timing of backwashes between different screening bodies 14.

Alternatively, the sequence of backwashes may be controlled by sequencing the delivery of air to the pulsing aerators 18. For example, the screening bodies 14 can be grouped into rows or arrays separated by dividing walls perpendicular to the weir 42 that rise above the level of the weir 42. In this example, the screening bodies in a row or array are backwashed together by feeding them with air only directly before their intended backwash time. The increase in water level resulting from the backwash carries the rejected materials over the weir 42. Alternatively, rows of screening bodies 14 parallel to the overflow weir 42 can be backwashed in a sequence progressing from the furthest row to the closest row. This results in a surface flow to carry the rejected materials towards the weir 42. Similarly, backwashing individual screening bodies 14 in rows perpendicular to the weir 42 progressing from the furthest screening bodies 14 to the closest screening bodies 14 results in a surface flow to carry the rejected materials towards the weir 42.

Some of the rejected materials may sink rather than being floated over the weir 42. Multiple collector pipes 30 may be placed side by side but separated with gaps, for example between 1 and 5 cm wide, to allow rejected materials to reach the bottom of the tank 10. A space is provided below the collector pipes 30 for these rejected materials to settle and accumulate. This rejected material is evacuated periodically, for example daily or weekly, through the drain 46. Alternatively, the settled rejected materials may be pumped out, for example by a sludge grinder pump, or by a geyser pump as described in U.S. Pat. No. 6,162,020 which is incorporated herein by this reference.

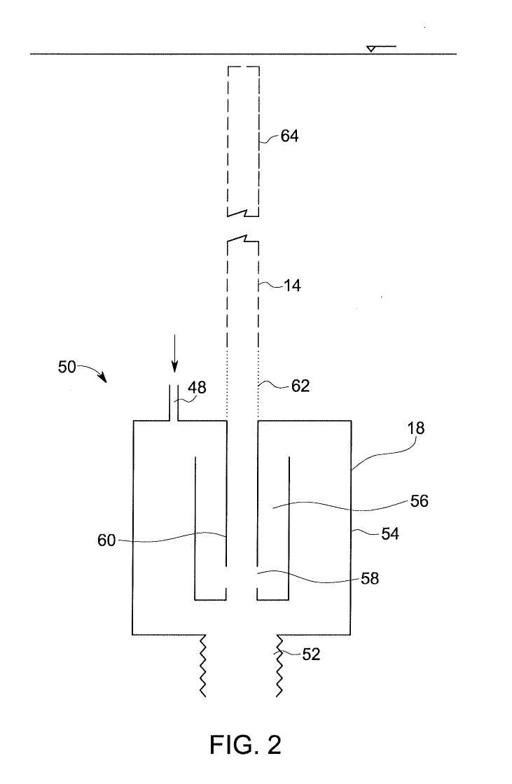

FIG. 2 shows a screening assembly 50 having a screening body 14 and pulsing aerator 18. Other screening assemblies 50 may have up to 20 screening bodies 14, for example between 6 and 12 screening bodies 14. The screening assembly 50 has a port 52 for connecting the screening assembly 50 to a collection pipe 30.

The pulsing aerator 18 is similar in operation to a geyser pump, as described in U.S. Pat. No. 6,162,020, or to the gas sparging device described in international publication WO 2011/028341 A1, both of which are incorporated herein by this reference. In general, the pulsing aerator 18 is structured to provide an open bottomed chamber adapted to hold an air pocket of variable volume above water that is in communication, directly or indirectly, with a free surface. The chamber is in communication with a structure forming a discharge passageway. The discharge passageway has a low point between an inlet in communication with the chamber and an outlet and so forms an inverted siphon. Air is fed into the chamber until the air pocket extends downwards to the level of the low point in the discharge passageway. At this time, some or all of the air in the chamber is released through the discharge passageway until the air pocket no longer reaches the inlet of the discharge passageway. The discharge passageway may be a closed conduit, in which case a generally single phase slug or pulse of gas is released after water in the discharge passageway is initially blown out. Alternatively, the discharge conduit may have an opening to the water in which case an air lift is created in the discharge conduit and a two phase pulse, or an air pulse followed by a liquid pulse, is produced.

The pulsing aerator 18 has an outer chamber 54 and an inner chamber 56 connected to one or more screening bodies 14. The inner chamber 56 is connected through one or more discharge ports 58 to the bottom of a riser tube 60 for each screening body 14. The top of the riser tube 60 is connected to a screening body 14 at or near the upper surface of the outer chamber 54. The inner chamber 56 works as a reverse siphon to intermittently discharge air, or an air-water mixture, to the riser tube 60. Air is introduced into the outer chamber 54 on a continuous basis through an air inlet 48 located, for example, at the top of the outer chamber 54. As discussed above, when a pocket of air builds up in the outer chamber 54 extending to the discharge ports 58, air is discharged through the inner chamber 56, through the discharge ports 58, and into the riser tube 60. When there are multiple riser tubes 60 and inner chambers 56 within a single outer chamber 54, all of the inner chambers 56 discharge air at about the same time.

A short lower section 62 of the screening body 14, for example 10% or less of the total length of the screening body 14, contains openings of a different size as compared to an upper section 64 of the screening body 14. The relative lengths of the lower section 62 and upper section 64 controls a fraction of the discharged that is used for floatation, as will be described further below.

An operating process comprises a series or filtration periods of, for example, between 1 and 10 minutes, separated by backwash events of, for example, 10 to 30 seconds. The backwash frequency is determined primarily by the size of the outer chamber 54 and the air flow rate. During filtration, water crosses the screening body 14 in a dead-end screening mode. Any materials larger than the openings in the screening body 14 are collected on its surface or settle down to the bottom of the tank 10. During that period, the outer chamber 54 fills with air at a pressure equivalent to the height of the water column above the outer chamber 54. When the air reaches the level of the discharge port 58, a reverse siphon is initiated and most or all of the volume of air is discharged in a short period of time into the riser tube 60.

The plug of air travelling upwards in the riser tube 60 first stops filtration through the screening body 14 and then reverses the flow and starts pushing water up. Since the screening body 14 is plugged by the cap 16 at the top, water in the screening body 14 must flow out through the openings in the screening body 14 causing a backwash. A fraction of the air crosses the lower section 62 of the screening body 14 forming fine bubbles that help float the detached materials to the surface and into the reject channel 44. Air released by the pulsing aerator 18 thus serves two functions of backwashing the screening body and floating the rejected materials. The amount of air used for each function can be adjusted by varying the length of the lower section 62 and the size of the openings in that section.

Even though each screening assembly 50 is backwashed periodically, the overall screening process is uninterrupted and forward flow through the static screen 12 as a whole occurs at a substantially constant flow rate. This is possible because there are a large number of screen assemblies 50, for example 50 or more or 100 or more, in a tank 10 and only a small portion of them, for example 20% or less or 10% or less, are in backwash mode at any time. The volume of screened water used to backwash an individual screening assembly 50 is minimal and is taken from other screening assemblies 50 connected to the same collector pipe 30 or header 32 or from the downstream section 28. Because the backwash water is take from downstream of the screening body 14, it does not foul the screening body 14 or the pulsing aerator 18.

The average frequency of backwashing can be adjusted by varying the constant flow rate of air fed to the screening assembly 50. Changing the air flow rate will change the frequency of backwashing without substantially changing the backwash conditions such as duration and flow rate.

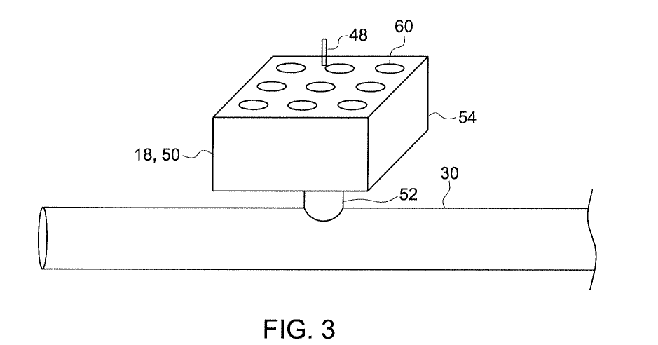

FIG. 3 shows a screening assembly 50 designed to hold nine screening bodies 14. This screening assembly 50 has a single outer chamber 54 but nine riser tubes 60. Each riser tube 60 is connected to a separate inner chamber 56 and a separate screening body 14. Alternatively, two or more, or all, of the riser tubes 60 can connected to a common inner chamber 56. The screening assembly 50 attaches to a collector pipe 30 through a port 52. The screening bodies 14, not shown, are self-standing and fairly rigid so they do not require restraining cages or enclosure frames. It is desirable to minimize the number of places that trash can catch and accumulate in the static screen 12.

Tubular screening bodies 14 may have a diameter of 10 to 100 mm, preferably 20 to 50 mm, and a length of 1 to 5 m, preferably 3 to 4 m. They are closed at the top by the cap 16 and connected to a pulsing aerator 18 and a collector tube 30 at the bottom. Tubular screening bodies may be made as described in international publication WO 2007/131151 A2, which is incorporated herein by this reference. Their wall structure can be a single layer or composite.

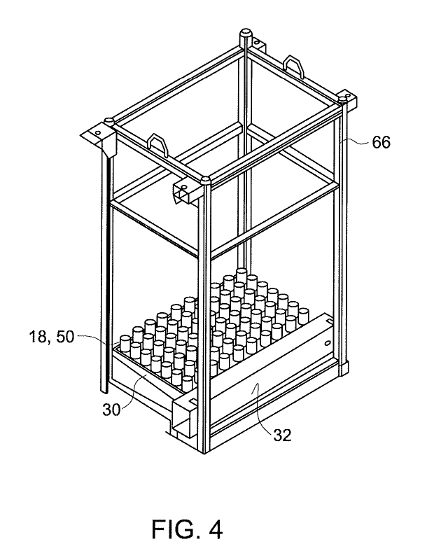

FIG. 4 shows an example of a screen frame 66 designed to hold an array of 10×7 screening assemblies 50, only partially shown to make more of the frame 66 visible. The screening assemblies 50 are mounted on collector pipes 30 which are connected to a header 32. The header 32 will be connected to an effluent discharge pipe 34 (not shown) when in use.

In general, the static screen 12 is used for removing solids from water. Screening bodies 14 with different opening sizes or shapes are used to target different particle sizes. Screening bodies with openings of about 0.5 to 2.0 mm may be used to remove trash, for example hair, lint or leaves, from raw wastewater or mixed liquor to protect downstream equipment such as immersed membrane units. One such application described in international publication WO 2007/131151 A2 comprises screening the mixed liquor of a membrane bioreactor (MBR) on a continuous basis to protect the membranes. In this application, the static screen 12 would be installed between the aeration tank or another process tank and the membrane tank.

Screening bodies 14 with smaller openings, for example from about of 0.02 to 0.3 mm, can be used as a micro sieving device for the primary treatment of wastewater to remove suspended solids and COD. The static screen 12 is more compact than a primary clarifier ordinarily used for primary treatment, possibly having less than 10% of the footprint of a primary clarifier, and would be simpler than existing mechanical micro sieving devices such as those made by Salsnes.

This written description uses examples to disclose the invention and also to enable any person skilled in the art to practice the invention. The patentable scope of the invention is defined by the claims, and may include other examples that occur to those skilled in the art.

We claim:

1. A static screen comprising,
a) a plurality of screening bodies;
b) one or more collection tubes; and,
c) a plurality of aeration devices,
wherein,
d) the plurality of screening bodies are attached to, an extend upwards from, the one or more collection tubes;
e) each of the plurality of aeration devices is adapted to discharge a gas into one or more of the plurality of screening bodies; and,
f) each of the plurality of aeration devices comprises a chamber connected to i) a source of a gas, ii) a discharge passageway in the form of an inverted siphon with an outlet near the bottom of one or more of the plurality of screening bodies and iii) to a downstream side of the plurality of screening bodies.

2. The static screen of claim 1 wherein the screening bodies are vertically oriented prismatic bodies.

3. The static screen of claim 2 wherein the screening bodies are tubes.

4. The static screen of claim 2 wherein lower sections of the screening bodies have smaller openings than upper sections of the screening bodies.

5. The static screen of claim 1 wherein the plurality of aeration devices are non-synchronized.

6. The static screen of claim 1 wherein the discharge passageway is open at a low point of the discharge passageway to the downstream side of the plurality of screening bodies.

7. The static screen of claim 6 wherein the discharge passageway comprises a tube connecting a screening body to a collector tube.

8. The static screen of claim 7 wherein the aeration devices are located above the collection tubes.

9. The static screen of claim 1 further comprising an immersed membrane located downstream of the screening bodies wherein the screening bodies have openings in the range of 0.5 to 2.0 mm.

10. The static screen of claim 1 wherein the screening bodies have openings in the range of 0.02 to 0.3 mm.

11. A process for screening water comprising the steps of,
a) providing a plurality of screening bodies; and,
b) operating each of the plurality of screening bodies in a process comprising periods of dead end filtration separated by backwashing procedures,
wherein,
c) on average over time, no more than 20% of the plurality of screening bodies are being backwashed simultaneously.

12. The process of claim 11 wherein the backwashing procedures comprise introducing a slug or pulse of air into the bottom of a screening body being backwashed.

13. The process of claim 12 wherein the backwashing procedures comprise producing fine bubbles from near the base of the screening body being backwashed.

14. The process of claim 11 wherein the screening bodies are located in a tank and further comprising a step of feeding water to be screened to the tank.

15. The process of claim 14 further comprising withdrawing water containing rejected solids from the tank upstream of the screening bodies.

16. The process of claim 15 wherein the water containing rejected solids is withdrawn substantially continuously over a weir.

17. The process of claim 16 comprising sequencing the backwashing of the screening bodies so as to enhance a surface flow towards the weir.

18. The process of claim 16 wherein the tank has a cover that is open at the weir.

19. The process of claim 14 wherein the screening bodies have openings in a range of about 0.02 to 0.3 mm and further comprising flowing screened effluent from the tank to an immersed membrane system.

20. The process of claim 14 wherein the screening bodies have openings in a range of about 0.02 to 0.3 mm and the water to be screened is municipal wastewater.
